(19) United States
(12) Patent Application Publication
(10) Pub. No.: US 2014/0093681 A1
(43) Pub. Date: Apr. 3, 2014

(54) PATTERNED CURVIFORM SURFACE OF GLASS AND METHOD FOR MANUFACTURE THE SAME

(71) Applicant: NAI-YUE LIANG, Taipei (TW)

(72) Inventor: NAI-YUE LIANG, Taipei (TW)

(21) Appl. No.: 14/098,536

(22) Filed: Dec. 6, 2013

Related U.S. Application Data
(63) Continuation-in-part of application No. 13/300,644, filed on Nov. 20, 2011, now abandoned.

(51) Int. Cl. C03C 21/00

(52) U.S. Cl. CPC C03C 21/002
USPC 428/141; 428/156; 428/172; 65/30.14

(57) ABSTRACT

A patterned curviform surface of glass includes a glass body having a smooth surface. The smooth surface has a plurality of compressive stress area, and the plurality of compressive stress area forms a predetermined pattern. Compressive stress retained in the compressive stress area is lager than 50 Mpa so that the plurality of compressive stress area will form a patterned curviform surface based on the predetermined pattern. A method for manufacturing the patterned curviform surface of glass includes forming a mask onto the smooth surface of surface roughness lower than 0.12 μm. The mask includes a plurality of hollow, and the plurality of hollow forms a predetermined pattern. The smooth surface is processed by a chemical ion tempering process to form a plurality of compressive stress area retaining compressive stress within the hollow of the mask. By removing the mask and cleaning the smooth surface, a curviform surface opposite to the predetermined pattern is formed to the smooth surface.

The present invention is a continuation in part (CIP) of U.S. patent application Ser. No. 13/300,644 which is assigned to the applicant of the present invention and thus the contents of U.S. patent application Ser. No. 13/300,644 is incorporated into the present invention as a part of the present invention.

### FIELD OF THE INVENTION

The present invention relates to glass of curviform surface and the manufacture method, and particular to a glass having an indistinct patterned curviform surface. The curviform surface of the glass will refract the light and project a distinct shadow of the predetermined pattern. Especially, the patterned curviform surface is formed by a chemical ion tempering process through a mask of the predetermined pattern.

### DESCRIPTION OF THE PRIOR ART

Projection lens is a lens having hidden pattern which is a curviform surface of minor curvature. When light is projected to the pattern, the curviform surface will refract the light and project a distinct shadow of a predetermined pattern. The novel effect is suitable for demonstrating a trend mark, decoration, or art work. The most earlier projection lens was produced in Western Han dynasty of ancient china. A copper mirror having a decorative pattern is used to project a distinct pattern of image. The decorative pattern on the copper mirror is formed by delicate scraping so as to form a curviform surface of minor curvature on the copper mirror surface. The process was time consuming and requires superior technique.

A U.S. published pattern of U.S. Pat. No. 5,080,940 discloses an equivalent method for the same effect. A finished reflective lens is processed by laser scribing to an opposite surface against a reflective surface thereof so as to form a pattern of curviform surface. However, extra work to the finished lens and the expensive laser process could cause a higher cost.

On the other hand, a Taiwan published pattern of no. M292695 discloses a projection lens formed by injection molding. A curved structure is formed to a plastic material of thickness lower than 3 mm. A curviform surface of small curvature is formed to an opposite side of the curved structure. A reflective layer is arranged to the curviform surface for projection. There is no extra scribing work needed in the application. However, such application can be applied to thin plate formed by injection molding or casting. It can not be used to thicker material or a flat plate having flat upper and lower surfaces such as a glass.

### SUMMARY OF THE PRESENT INVENTION

Accordingly, the primary object of the present invention is to provide a glass of curviform surface and the manufacture method for the same. An indistinct patterned curviform surface is formed to a smooth surface of a glass body by a chemical ion tempering process. The curviform surface will refract the light and project a distinct shadow of the predetermined pattern.

### BRIEF DESCRIPTION OF THE DRAWINGS

FIG. 1 is a schematic view showing separated glass and mask of the present invention.

FIG. 2 is a schematic view showing the glass attached by the mask of the present invention.

FIG. 3 is a schematic view showing a finish glass of the present invention.

FIG. 4 is a cross-section view showing the finish glass of the present invention.

FIG. 5 is a schematic view showing the operation of the present invention.

FIG. 6 is a cross-section view showing the operation of another embodiment of the present invention.

### DETAILED DESCRIPTION OF THE IVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

A preferable embodiment of the title according to the present invention includes the following steps.

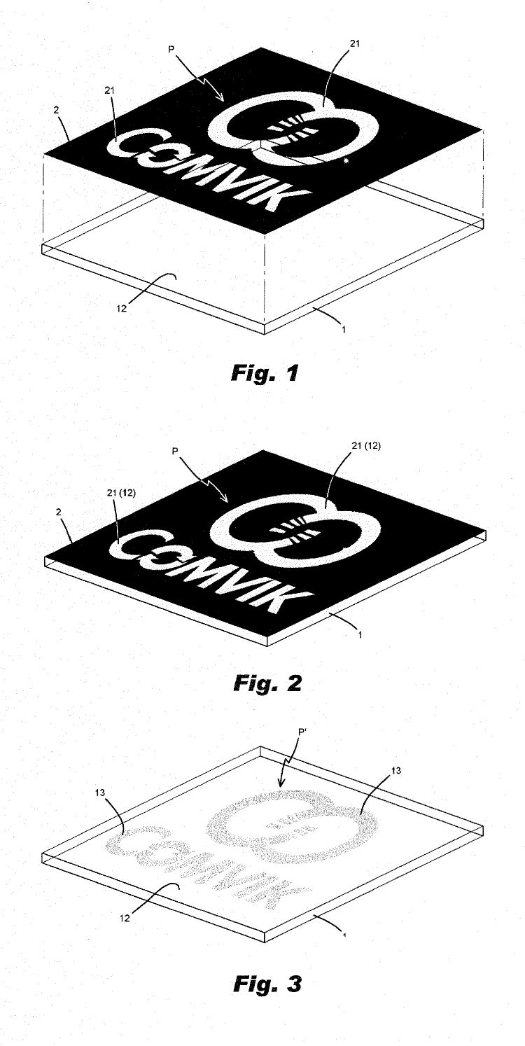

A glass 1 of a flat soda lime glass having a flat upper and lower surface is selected in the embodiment. The roughness Ra of a smooth surface 12 of the upper surface is about 0.08 μm. A mask 2 is tightly attached to the smooth surface 12 as shown in FIGS. 1 and 2. The mask 2 has a pattern P including a plurality of hollow 21. The cross-section of the hollow 21 is irregular geometric surface. However, the area of the cross-section is larger than 0.2 mm² for allowing a chemical tempering liquid to pass. The mask 2 is made of acid-proof silicone which withstands temperature up to 380° C. . In the present embodiment, molten silicone is stenciled to the smooth surface 12 so as to form the mask 2. Preferably, the glass 1 with the silicone mask 2 is placed into an oven to bake and slowly cooled down to room temperature (about 25° C.) so as to improve the adherence.

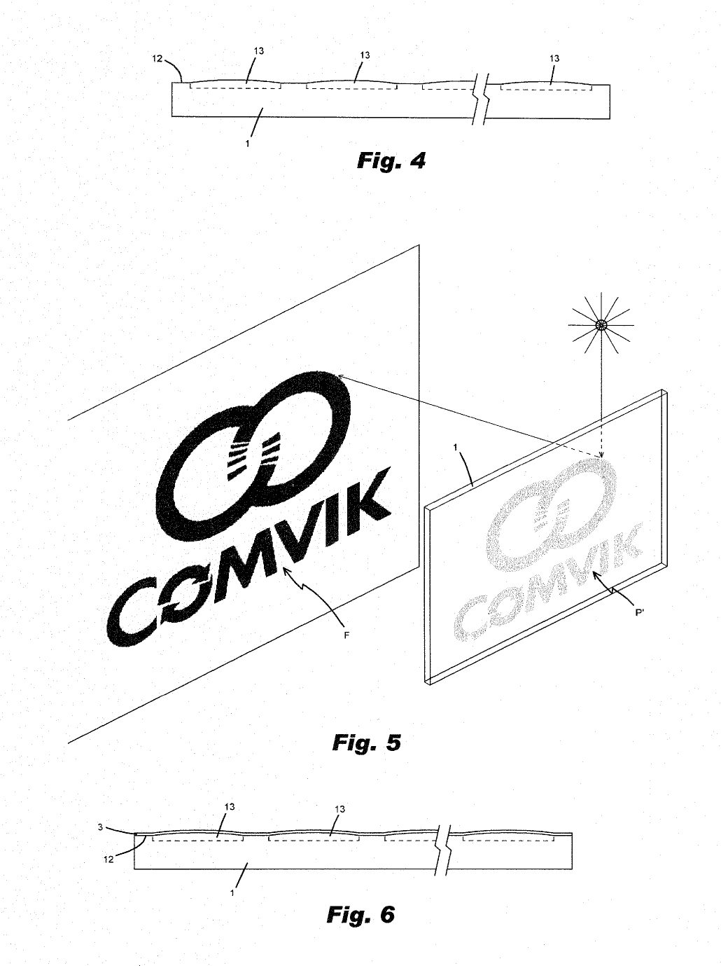

The smooth surface 12 is processed by a chemical tempering process by soaking the smooth surface 12 with the mask 2 into a bathing tank (not shown in figure). The bathing tank is full of 380 to 450° C. molten tempering liquid. In the present embodiment, the tempering liquid for tempering the soda lime glass is a solution of potassium nitrate (KNO₃). During the tempering process, ion exchange operation will happen on the smooth surface 12 within the hollow 21 of the mask 2. The smaller sodium ions on glass surface will be exchanged by the larger potassium ions of the tempering liquid. A tempered surface layer retaining compressive stress is thus formed to the glass surface. However, ion exchange operation will not happen on glass surface under the sheltered by the mask 2 to form the compressive stress layer. Through the tempering process, a plurality of compressive stress area 13 is formed to the smooth surface 12 as shown in FIGS. 3 and 4. The soaking of the glass usually takes 0.5 to 7 hours, and the compressive stress retained on the tempered portion is about 50 to 800 MPa. Obviously, the ion exchange operation involves contents of liquid, temperature, duration, numbers of substrate, using of multiple bathing tanks, or extra steps such as annealing, rinse. Those conditions and steps can be adjusted to control the depth and surface compressive stress of the layer during the tempering process.

The last step of the method of the present invention is to remove the mask 2 attached to the substrate 1 through stripper or polishing. The substrate 1 is finally washed by detergent (or water).

Through above steps, a patterned curviform surface of the glass is formed. A pattern formed by a plurality of tempered area 13 is formed to the smooth surface. The compressive stress retained on the tempered area is larger than 50 MPa. The tempered area will have slight protrusion by the strain so as to form an indistinct pattern P opposite to the pattern of the mask 2. When light is projected to the pattern, the curviform surface on the smooth surface of the glass will refract the light and project a distinct shadow F of the predetermined pattern P (as shown in FIG. 5).

In another preferable embodiment of the present invention, a reflective layer 3 is arranged above the smooth surface 12 having the curviform surface. The reflective layer 3 is preferable a metal film of Ra about 0.8 μm and a thickness about 80 μm. The reflective layer 3 will also have a curviform pattern P′ as shown in FIG. 6. The metal reflective layer 3 can be formed by coating, spraying, electroplating, sputtering, chemical vapor deposition (CVD), physical vapor deposition (PVD), or surface mount technology (SMT).

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A patterned curviform surface of glass comprising a smooth surface of a glass body; the smooth surface having a plurality of compressive stress area; the plurality of compressive stress area forming a predetermined pattern; compressive stress retained in the compressive stress area being lager than 50 Mpa so that the plurality of compressive stress area will slight protrusion by the strain and a patterned curviform surface is formed.

2. The patterned curviform surface of glass as claimed in claim 1, wherein the glass body is one of soda-lime glass or aluminosilcate glass.

3. The patterned curviform surface of glass as claimed in claim 1, wherein the surface roughness of the smooth surface is lower than 0.12 μm.

4. The patterned curviform surface of glass as claimed in claim 1, wherein the smooth surface is one of a flat, arc, or spherical surface.

5. The patterned curviform surface of glass as claimed in claim 1, wherein the glass body is a glass plate having at least one flat upper and lower surface.

6. The patterned curviform surface of glass as claimed in claim wherein the thickness of the glass plate is larger than 0.5 mm.

7. The patterned curviform surface of glass as claimed in claim wherein a reflective layer is formed to the smooth surface.

8. The patterned curviform surface of glass as claimed in claim 1, wherein the surface roughness of the reflective surface is lower than 0.12 μm.

9. The patterned curviform surface of glass as claimed in claim 7, wherein the reflective layer is a metal film of a thickness lower than 100 μm.

10. A method for manufacturing a patterned curviform surface of glass comprising:
a. preparing of a glass body, the glass body having at least a smooth surface;
b. forming a mask onto the smooth surface of the glass substrate; the mask including a plurality of hollow; the plurality of hollow forming a predetermined pattern; the mask being tightly attached to the smooth surface;
c. performing a chemical tempering process to the glass body by soaking the glass body with the mask into a bathing tank full of molten tempering liquid for ion exchange operation; a plurality of compressive stress area retaining compressive stress being form to the smooth surface within the hollow of the mask; and
d. removing the mask from the smooth surface and cleaning the smooth surface; a curviform surface opposite to the predetermined pattern being formed by the plurality of compressive stress area.

11. The method for manufacturing a patterned curviform surface of glass as claimed in claim 10, wherein the glass body is one of soda-lime glass or aluminosilcate glass.

12. The method for manufacturing a patterned curviform surface of glass as claimed in claim 10, wherein the surface roughness of the smooth surface is lower than 0.12 μm.

13. The method for manufacturing a patterned curviform surface of glass as claimed in claim 10, wherein the glass body is a glass plate of a thickness larger than 0.5 mm.

14. The method for manufacturing a patterned curviform surface of glass as claimed in claim 10, wherein the mask is made of acid-proof, rubber which withstands temperature up to 380° C.

15. The method for manufacturing a patterned curviform surface of glass as claimed in claim 14, wherein the rubber is silicone.

16. The method for manufacturing a patterned curviform surface of glass as claimed in claim 10, wherein a cross-section of the hollow of the mask is one of a circle or rectangle.

17. The method for manufacturing a patterned curviform surface of glass as claimed in claim 10, wherein the cross-section area of the hollow is larger than 0.2 mm².

18. The method for manufacturing a patterned curviform surface of glass as claimed in claim 10, wherein the tempering liquid is one or mixture of nitrate, sulfate, alkali metal chloride solution.

19. The method for manufacturing a patterned curviform surface of glass as claimed in claim 18, wherein the tempering liquid is a solution of potassium nitrate (KNO₃).

20. A method for manufacturing a patterned curviform surface of glass comprising:
a. preparing of a glass body, the glass body having at least a smooth surface;
b. forming a mask onto the smooth surface of the glass substrate; the mask including a plurality of hollow; the plurality of hollow forming a predetermined pattern; the mask being tightly attached to the smooth surface;
c. performing a chemical tempering process to the glass body by soaking the glass body with the mask into a bathing tank full of molten tempering liquid for ion exchange operation; a plurality of compressive stress area retaining compressive stress being form to the smooth surface within the hollow of the mask;
d. removing the mask from the smooth surface and cleaning the smooth surface; a curviform surface opposite to the predetermined pattern being formed by the plurality of compressive stress area; and
e. forming a reflective layer to the smooth surface; the reflective layer having a patterned curviform surface of the predetermined pattern.
wherein the surface roughness of the reflective layer is lower than 0.12 μm;
wherein the reflective layer is a metal film of a thickness lower than 100 μm; and
wherein the metal reflective layer is formed by one of coating, spraying, electroplating, sputtering, chemaical vapor deposition, physical vapor deposition, or sureface mount technology.
